(19) United States
(12) Patent Application Publication
(10) Pub. No.: US 2017/0050221 A1
(43) Pub. Date: Feb. 23, 2017

(54) CLEANING CLOTH

(71) Applicant: Suzan Theresa Naskrent, Port Charlotte, FL (US)

(72) Inventor: Suzan Theresa Naskrent, Port Charlotte, FL (US)

(21) Appl. No.: 15/216,206

(22) Filed: Jul. 21, 2016

Related U.S. Application Data
(60) Provisional application No. 62/208,641, filed on Aug. 22, 2015.

(51) Int. Cl. B08B 1/00; A47L 17/00; A47K 7/02

(52) U.S. Cl. CPC B08B 1/006; A47K 7/02; A47L 17/00

(57) ABSTRACT

A 4″×5″ and 5″×7′recycled and or re-purposed cotton terrycloth wrapped in acrylic netting with stitching around the periphery and on it's face. It's unique sewn pattern design allows food/cheese/grease to be captured and yet be rinsed clean. It is re-usable and can be laundered for use multiple times.

### CROSS-REFERENCE TO RELATED APPLICATION

This application claims the benefit of priority of U.S. provisional application No. 62/208,641, filed Aug. 22, 2015, the contents of which are herein incorporated by reference.

### BACKGROUND OF THE INVENTION

The present invention relates to cleaning supplies, and more particularly, to dish cloths for cleaning dishes and surfaces in a kitchen environment as well as other surfaces in and around the home environment.

Cleaning supplies such as sponges, particularly those utilized in kitchens and cooking areas are susceptible to the formation of bacteria and odors, as well as the accumulation of food particles. For these reasons, it is recommended that sponges should usually be thrown in the garbage after a week or two to avoid contamination of food preparation areas with harmful bacteria. The disposal of these articles (sponges) are bad for environment and takes many many years to decompose in the landfills.

As can be seen, there is a need for an improved cleaning device that allows food/cheese/grease to rinse clean. It is re-usable and can be laundered for use multiple times.

### SUMMARY OF THE INVENTION

In one aspect of the present invention, a cleaning cloth includes: a first layer of cloth material; and a layer of mesh netting material stitched to the first layer with a border stitch and an interior stitch pattern. The first layer is a terry cloth and is preferably one of a recycled cloth or repurposed cloth.

In some embodiments, the peripheral stitch is a zig zag stitch that extends around a periphery of the cleaning cloth and the interior stitch is a zig zag stitch radially emanating from a central portion of the cleaning cloth to the peripheral stitch.

In some embodiments, the layer of mesh netting comprises a nylon material. The layer of mesh netting may be applied to a first surface and a second surface of the terry cloth. The layer of mesh netting may also be applied as a plurality of layers to each of the first surface and the second surface. In certain preferred embodiments, the interior stitch comprises eight radially emanating stitches.

These and other features, aspects and advantages of the present invention will become better understood with reference to the following drawings, description and claims.

### BRIEF DESCRIPTION OF THE DRAWINGS

FIG. 1 is a perspective view of the invention shown in use;

FIG. 2 is a perspective view of the invention;

FIG. 3 is an exploded view of the invention; and

FIG. 4 is a section view of the invention taken from 4-4 in FIG. 1 illustrated without the hand for clarity.

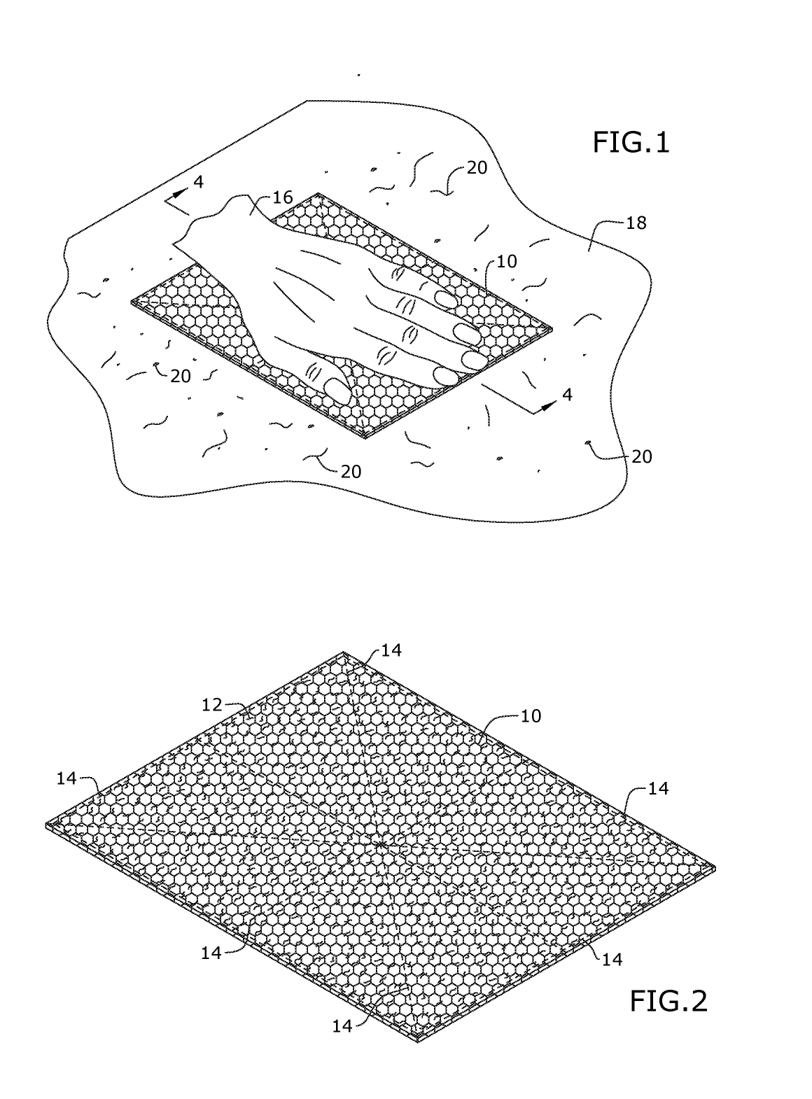

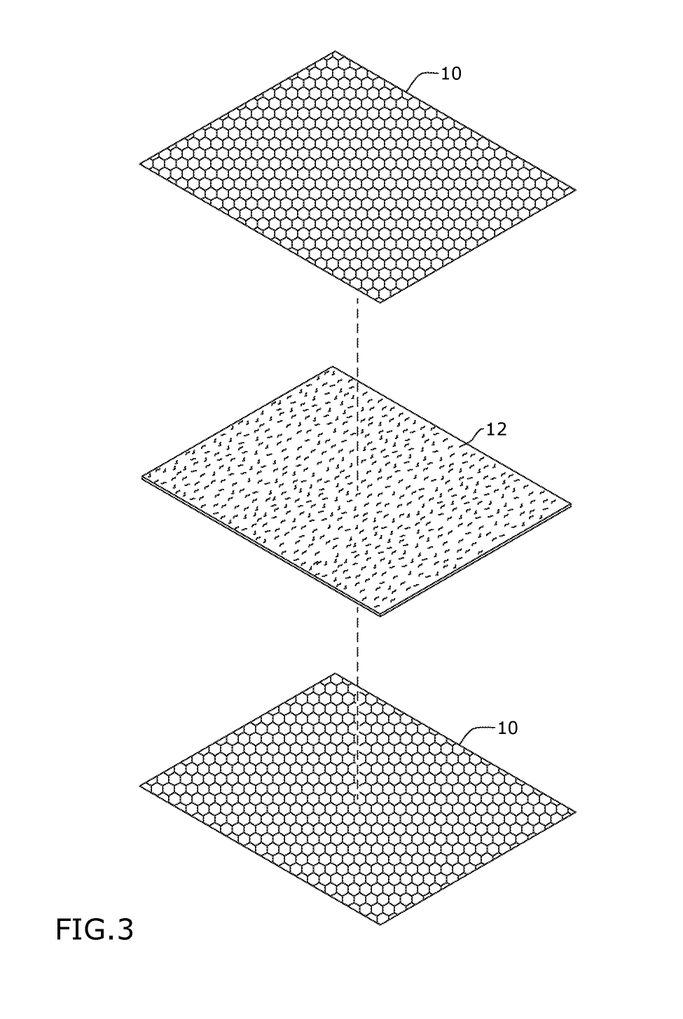

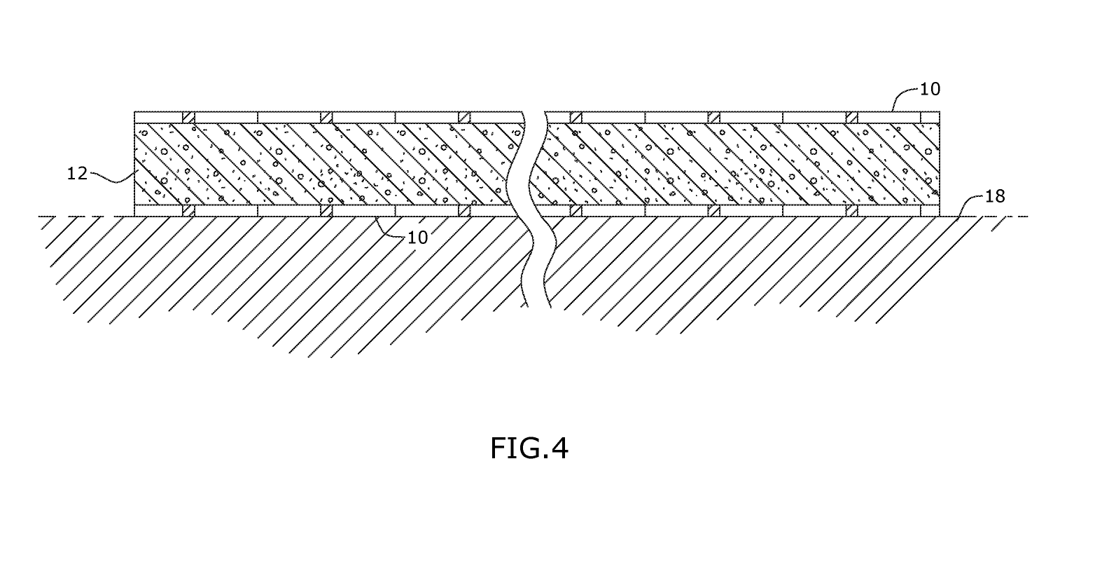

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved cleaning cloth that avoids the accumulation and retention of food particles that lead to the formation of harmful bacteria and unpleasant odors.

The cleaning cloth of the present invention includes a first layer of terry cloth material 12 and a layer of nylon netting 10 material that is sewn to at least one face of the terry cloth layer 12. The netting 10 material serves as a mild abrasive material that is capable of capturing and releasably retaining food particles with the cleaning cloth to remove the particles from food preparation surfaces 18 and dishware. The unique design of the cleaning cloth provides the ability to be washed clean and free of food particles 20 such as cheese and grease.

In a preferred embodiment, the terry cloth layer 10 is formed from recycled or re-purposed cotton terry cloth. In other preferred embodiments, the netting 10 material is sewn to a front face and a back face of the first terry cloth layer 12. The cleaning cloth so formed can be laundered multiple times and is reusable.

As seen in reference to FIG. 2, the unique sewn pattern securing the netting 10 layer to the terry cloth layer 12. The stitch pattern 14 includes a border stitch extending around a periphery of the cleaning cloth and an interior stitch having a plurality of radially emanating stitches extending from a central portion of the cleaning cloth to the border stitch 14. The interior stitch 14 forms a plurality of pockets that facilitate the capture of food particles 18 and debris. In addition, the interior stitch 14 assists with retaining the netting layer 10 in position over the terry cloth layer 10 to prevent slippage of the netting layer 10 when the cleaning cloth is utilized in scrubbing.

As will be appreciated, the cleaning cloth of the present invention can also be utilized for facial/body scrubs for exfoliation and a variety of other uses that may benefit from a mild abrasive and the ability to capture dirt and other debris.

In use, the terry cloth 12 absorbs and holds water and soap. The nylon netting layer 10 wrapped around terry cloth 12 acts as a scrubbing agent. The unique sewn pattern 14 allows it to rinse clean.

The cleaning cloth may be cut to a desired dimension, such as, by way of non-limiting example, by cutting the terry cloth 12 in a 4″×5″ and 5″×7″ piece. Wrap 48″ and 58″ acrylic netting 10 around the respected size terry cloth. The border stitch 14 may be sew around the outside edges with zig zag stitch. The interior stitch 14 may be formed by sewing a zig zag stitch from corner to corner through a middle of the cleaning cloth creating a substantially “X”. An additional zig zag stitch straight lines across cloth in the middle, vertically and horizontally.

It should be understood, of course, that the foregoing relates to exemplary embodiments of the invention and that modifications may be made without departing from the spirit and scope of the invention as set forth in the following claims.

What is claimed is:

1. A cleaning cloth comprising,
a first layer of cloth material; and
a layer of mesh netting material stitched to the first layer with a border stitch and an interior stitch pattern.

2. The cleaning cloth of claim 1, wherein the first layer is a terry cloth.

3. The cleaning cloth of claim 2, wherein the terry cloth is one of a recycled cloth or repurposed cloth.

4. The cleaning cloth of claim 1, wherein the peripheral stitch is a zig zag stitch that extends around a periphery of the cleaning cloth.

5. The cleaning cloth of claim 4, wherein the interior stitch is a zig zag stitch radially emanating from a central portion of the cleaning cloth to the peripheral stitch.

6. The cleaning cloth of claim 5, wherein the layer of mesh netting comprises a nylon material.

7. The cleaning cloth of claim 6, wherein the layer of mesh netting is applied to a first surface and a second surface of the terry cloth.

8. The cleaning cloth of claim 7, wherein the layer of mesh netting is applied as a plurality of layers to each of the first surface and the second surface.

9. The cleaning cloth of claim 8, wherein the interior stitch comprises eight radially emanating stitches.
